(19) United States
(12) Patent Application Publication
(10) Pub. No.: US 2002/0135837 A1
(43) Pub. Date: Sep. 26, 2002

(54) Signal transmission system

(75) Inventor: Masatoshi Katayama, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 09/986,539

(22) Filed: Nov. 9, 2001

(30) Foreign Application Priority Data
Mar. 22, 2001 (JP) 2001-083616

(51) Int. Cl. H04J 14/02; H04B 10/00

(52) U.S. Cl. 359/124; 359/152

(57) ABSTRACT

A signal transmission system includes a first transmission unit for distributing and transmitting a downward optical signal from a downward signal transmitting unit to a plurality of downward signal receiving units, and a second transmission unit for multiplexing a plurality of upward optical signals applied thereto and transmitting the plurality of upward optical signals multiplexed, and for distributing and transmitting a downward signal applied thereto. The system also comprises a first WDM unit for applying the plurality of upward optical signals multiplexed and transmitted thereto by the second transmission unit to an upward signal receiving unit, and for applying an optical signal transmitted by an information transmitting unit, as a downward optical signal, to the second transmission unit, and a second WDM unit for applying a plurality of upward optical signal transmitted by a plurality of upward signal transmitting units to the second transmission unit, and for applying the optical signal from the information transmitting unit transmitted thereto by the second transmission unit to an information receiving unit.

### BACKGROUND OF THE INVENTION

1. Field of the Invention

The present invention relates to a signal transmission system that employs an optical fiber as a communication medium.

2. Description of the Prior Art

FIG. 10 is a block diagram showing the structure of a prior art signal transmission system. In the figure, reference numeral 1 denotes a station apparatus, reference numeral 2 denotes customer premises equipment, reference numeral 11 denotes a laser diode that converts a downward electrical signal into a downward optical signal having a wavelength of 1480 nm to 1500 nm and transmits the downward optical signal, reference numeral 12 denotes a photo diode that receives an upward optical signal having a wavelength of 1260 nm to 1360 nm and converts the received upward optical signal into an electrical signal, and reference numeral 13 denotes a wavelength division multiplexer (WDM) that allows only downward optical signals to pass therethrough for a channel from a port thereof on the side of the laser diode 11 to a port thereof on the side of another WDM 16, and that allows only upward optical signals to pass therethrough for a channel from the port thereof on the side of the other WDM 16 to a port thereof on the side of the photo diode 12.

Reference numeral 14 denotes a video signal transmitter that generates and transmits a video signal, and reference numeral 15 denotes a laser diode that converts the video signal (electrical signal) sent from the video signal transmitter 14 into an optical signal having a wavelength of 1550 nm to 1560 nm (referred to as video optical signal from here on) and that sends out the video optical signal. The WDM 16 allows only downward and upward optical signals to pass therethrough for a channel between a port thereof on the side of a star coupler 18 to a port thereof on the side of the WDM 13, and that allows only video optical signals to pass therethrough for a channel from a port thereof on the side of the laser diode 15 to the port thereof on the side of the star coupler 18.

Reference numeral 17 denotes an optical fiber. The star coupler 18 distributes an optical signal from the WDM 16 to several locations. The star coupler 18 also multiplexes a plurality of optical signals received into an upward optical signal. Reference numeral 19 denotes a WDM that allows only downward and upward optical signals to pass therethrough for a channel between a port thereof on the side of the star coupler 18 to a port thereof on the side of another WDM 20, and that allows only video optical signals to pass therethrough for a channel from the port thereof on the side of the star coupler 18 to a port thereof on the side of a photo diode 23. The WDM 20 allows only downward optical signals to pass therethrough for a channel from a port thereof on the side of the WDM 19 to a port thereof on the side of a photo diode 22, and that allows only upward optical signals to pass therethrough for a channel from a port thereof on the side of a laser diode 21 to the port thereof on the side of the WDM 19. The laser diode 21 converts an upward electrical signal into an upward optical signal and then transmits the upward optical signal. The photo diode 22 receives a downward optical signal and then converts the received downward optical signal into an electrical signal. Reference numeral 23 denotes a photo diode that receives a video optical signal and converts the received video optical signal into an electrical signal, reference numeral 24 denotes a video signal receiver that receives a video signal which is the electrical signal from the photo diode 23, and reference numeral 25 denotes a termination.

In operation, when the laser diode 11 of the station apparatus 1 emits a downward optical signal, the downward optical signal travels through the optical fiber 17 and then reaches the star coupler 18 after it passes through the WDMs 13 and 16 included in the station apparatus. The star coupler 18 distributes the downward optical signal to only a number of pieces of customer premises equipment 2. As a result, the downward optical signal is received and is converted into an electrical signal by the photo diode 22 of each customer premises equipment 2 after it passes through the WDMs 19 and 20 provided for each customer premises equipment 2.

When the laser diode 21 of each customer premises equipment 2 emits an upward optical signal, the upward optical signal travels through the optical fiber 17 and then reaches the star coupler 18 after it passes through the WDMs 20 and 19 provided for each customer premises equipment 2. The star coupler 18 multiplexes a plurality of upward optical signals, the number of which corresponds to the number of pieces of customer premises equipment 2. As a result, the plurality of upward optical signals multiplexed are received and are converted into an electrical signal by the photo diode 12 of the station apparatus 1 after it passes through the WDMs 16 and 13 included in the station apparatus 1.

When the laser diode 15 of the station apparatus 1 emits a video optical signal, the video optical signal travels through the optical fiber 17 and then reaches the star coupler 18 after it passes through the WDM 16 included in the station apparatus. The star coupler 18 distributes the video optical signal to only the number of pieces of customer premises equipment 2. As a result, the video optical signal is received and is converted into an electrical signal by the photo diode 23 of each customer premises equipment 2 after it passes through the WDM 19 provided for each customer premises equipment 2. However, some customers do not need the reception of the video optical signal. Therefore, some pieces of customer premises equipment 2 do not include a photo diode 23 and a video signal receiver 24. In this case, the video optical signal is terminated by the termination 25 disposed for each customer premises equipment 2.

FIG. 11 is a graph showing insertion loss characteristics of the WDM 19. In the figure, A shows the insertion loss characteristics for a channel from a port on the side of corresponding customer premises equipment 2 to a port on the side of the star coupler 18, and B shows the insertion loss characteristics for a channel from the port on the side of the star coupler 18 to a port on the side of the video signal receiver 24. It is apparent from FIG. 11 that those insertion loss characteristics change abruptly over a narrow range of wavelengths from 1500 nm and 1550 nm (the width of the wavelength range=50 nm). Therefore, it is difficult to design the WDM 19, and hence the cost of the WDM 19 rises.

A problem with a prior art signal transmission system constructed as above is that although it can transmit not only upward and downward optical signals but also a video optical signal, an expensive WDM 19 has to be provided regardless of whether each customer has a video signal receiver for receiving a video optical signal and therefore the cost of building the system rises and the transmission range of optical signals is shortened by the transmission loss in the WDM 19.

### SUMMARY OF THE INVENTION

The present invention is proposed to solve the above-mentioned problems, and it is therefore an object of the present invention to provide a signal transmission system in which the number of WDMs can be reduced, thereby reducing the cost of building the system, and in which the transmission range of optical signals can be lengthened.

In accordance with an aspect of the present invention, there is provided a signal transmission system comprising: a first transmission unit for distributing and transmitting a downward optical signal transmitted by a downward signal transmitting unit to a plurality of downward signal receiving units; a second transmission unit for multiplexing a plurality of upward optical signals applied thereto and transmitting the plurality of upward optical signals multiplexed, and for distributing and transmitting a downward signal applied thereto; an information transmitting unit for transmitting an optical signal that-Carries specific information; a first WDM unit for applying the plurality of upward optical signals multiplexed and transmitted thereto by the second transmission unit to an upward signal receiving unit, and for applying the optical signal transmitted by the information transmitting unit, as a downward optical signal, to the second transmission unit; a plurality of upward signal transmitting units each for transmitting an upward signal; an information receiving unit for receiving an optical signal that carries specific information; and a second WDM unit for applying a plurality of upward optical signals transmitted by the plurality of upward signal transmitting units to the second transmission unit, and for applying the optical signal from the information transmitting unit transmitted thereto by the second transmission unit to the information receiving unit. Accordingly, the cost of building the system can be reduced, and the transmission range of optical signals can be lengthened.

In accordance with a preferred embodiment of the present invention, the information transmitting unit is a video signal transmitting unit for transmitting the optical signal based on a video signal. As an alternative, the information transmitting unit is a data signal transmitting unit for transmitting the optical signal based on a data signal. Preferably, the optical signal transmitted by the information transmitting unit has a wavelength longer than those of the plurality of optical signals transmitted by the plurality of upward signal transmitting units. Accordingly, each of the plurality of upward signal transmitting units can be prevented from malfunctioning even if no WDM is placed between the second transmission unit and each of the plurality of upward signal transmitting units.

In accordance with another aspect of the present invention, there is provided a signal transmission system comprising: a downward signal transmitting unit for transmitting a downward optical signal; a first transmission unit for distributing and transmitting a downward optical signal applied thereto; a second transmission unit for multiplexing a plurality of upward optical signals transmitted by a plurality of upward signal transmitting units and for transmitting the plurality of upward optical signals multiplexed; an information transmitting unit for transmitting an optical signal that carries specific information; a first WDM unit for applying the downward optical signal transmitted by the downward signal transmitting unit and the optical signal transmitted by the information transmitting unit to the first transmission unit; an information receiving unit for receiving an optical signal that carries specific information; and a second WDM unit for applying the downward optical signal distributed and transmitted thereto by the first transmission unit to a plurality of downward signal receiving units, and for applying the optical signal from the information transmitting unit transmitted thereto by the first transmission unit to the information receiving unit. Accordingly, the cost of building the system can be reduced, and the transmission range of optical signals can be lengthened.

In accordance with a preferred embodiment of the present invention, the information transmitting unit is a video signal transmitting unit for transmitting the optical signal based on a video signal. As an alternative, the information transmitting unit is a data signal transmitting unit for transmitting the optical signal based on a data signal. Preferably, the optical signal transmitted by the information transmitting unit has a wavelength longer than those of the plurality of optical signals transmitted by the plurality of upward signal transmitting units. Accordingly, each of the plurality of upward signal transmitting units can be prevented from malfunctioning even if no WDM is placed between the second transmission unit and each of the plurality of upward signal transmitting units.

In accordance with a further aspect of the present invention, there is provided a signal transmission system comprising: a first transmission unit for distributing and transmitting a downward optical signal transmitted by a downward signal transmitting unit to a plurality of downward signal receiving units; a second transmission unit for multiplexing a plurality of upward optical signals transmitted by a plurality of upward signal transmitting units and transmitting the plurality of upward optical signals multiplexed, and for distributing and transmitting a downward optical signal applied thereto; an information transmitting unit for transmitting an optical signal that carries specific information; a WDM unit for applying the plurality of multiplexed upward optical signals transmitted by the second transmission unit to an upward signal receiving unit, and for applying the optical signal transmitted by the information transmitting unit, as a downward optical signal, to the second transmission unit; and an information receiving unit for receiving an optical signal that carries specific information, the second transmission unit transmitting the optical signal from the WDM unit to the information receiving unit. Accordingly, the cost of building the system can be reduced, and the transmission range of optical signals can be lengthened.

In accordance with a preferred embodiment of the present invention, the information transmitting unit is a video signal transmitting unit for transmitting the optical signal based on a video signal. As an alternative, the information transmitting unit is a data signal transmitting unit for transmitting the optical signal based on a data signal. Preferably, the optical signal transmitted by the information transmitting unit has a wavelength longer than those of the plurality of optical signals transmitted by the plurality of upward signal transmitting units. Accordingly, each of the plurality of upward signal transmitting units can be prevented from malfunctioning even if no WDM is placed between the second transmission unit and each of the plurality of upward signal transmitting units.

In accordance with another aspect of the present invention, there is provided a signal transmission system comprising: a downward signal transmitting unit for transmitting a downward optical signal; a first transmission unit for distributing and transmitting a downward optical signal applied thereto; a second transmission unit for multiplexing a plurality of upward optical signals transmitted by a plurality of upward signal transmitting units and for transmitting the plurality of upward optical signals multiplexed; an information transmitting unit for transmitting an optical signal that carries specific information; a WDM unit for applying the downward optical signal transmitted by the downward signal transmitting unit and the optical signal transmitted by the information transmitting unit to the first transmission unit; and an information receiving unit for receiving an optical signal that carries specific information, the first transmission unit transmitting the optical signal applied thereto from the WDM unit to the information receiving unit. Accordingly, the cost of building the system can be reduced, and the transmission range of optical signals can be lengthened.

In accordance with a preferred embodiment of the present invention, the information transmitting unit is a video signal transmitting unit for transmitting the optical signal based on a video signal. As an alternative, the information transmitting unit is a data signal transmitting unit for transmitting the optical signal based on a data signal. Preferably, the optical signal transmitted by the information transmitting unit has a wavelength longer than those of the plurality of optical signals transmitted by the plurality of upward signal transmitting units. Accordingly, each of the plurality of upward signal transmitting units can be prevented from malfunctioning even if no WDM is placed between the second transmission unit and each of the plurality of upward signal transmitting units.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a signal transmission system according to a first embodiment of the present invention;

FIG. 2 is a graph showing insertion loss characteristics of a WDM included in the signal transmission system according to the first embodiment of the present invention of FIG. 1;

FIG. 3 is a block diagram showing the structure of a signal transmission system according to a second embodiment of the present invention;

FIG. 4 is a block diagram showing the structure of a signal transmission system according to a third embodiment of the present invention;

FIG. 5 is a block diagram showing the structure of a signal transmission system according to a variant of the third embodiment of the present invention;

FIG. 6 is a block diagram showing the structure of a signal transmission system according to a fourth embodiment of the present invention;

FIG. 7 is a block diagram showing the structure of a signal transmission system according to a fifth embodiment of the present invention;

FIG. 8 is a block diagram showing the structure of a signal transmission system according to a sixth embodiment of the present invention;

FIG. 9 is a block diagram showing the structure of a signal transmission system according to a variant of the sixth embodiment of the present invention;

FIG. 10 is a block diagram showing the structure of a prior art signal transmission system; and

FIG. 11 is a graph showing insertion loss characteristics of a WDM included in the prior art signal transmission system of FIG. 10.

### DETAILED DESCRIPTION OF THE PREFERRED EMBODIMENTS

Embodiment 1.

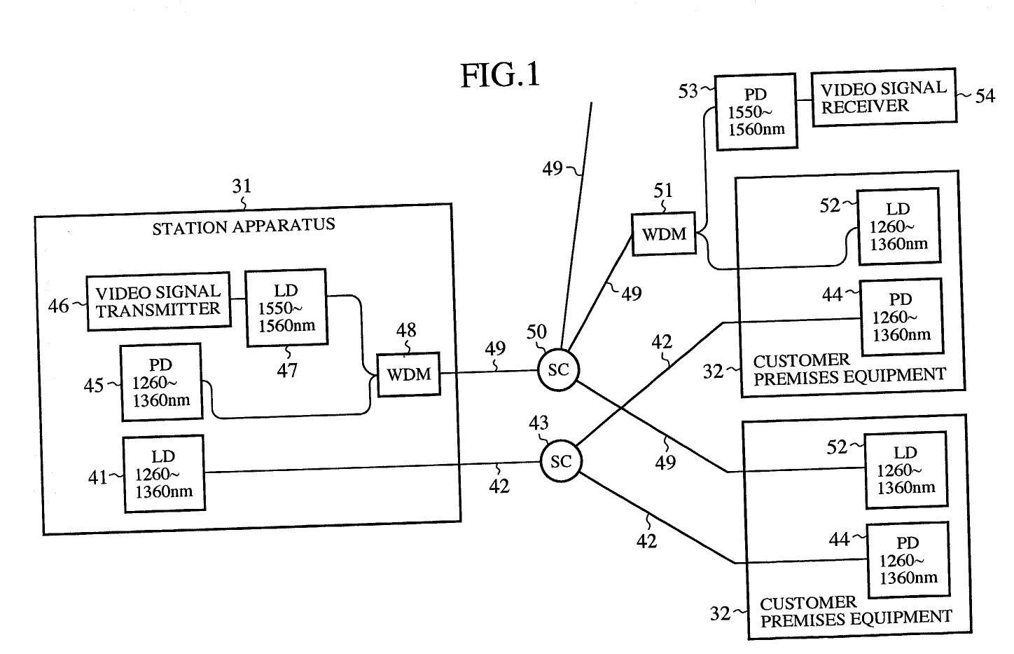

FIG. 1 is a block diagram showing the structure of a signal transmission system according to a first embodiment of the present invention. In the figure, reference numeral 31 denotes a station apparatus, reference numeral 32 denotes customer premises equipment, reference numeral 41 denotes a laser diode (downward signal transmitting means) that converts a downward electrical signal into a downward optical signal having a wavelength of 1260 nm to 1360 nm and transmits the downward optical signal, reference numeral 42 denotes an optical fiber, and reference numeral 43 denotes a star coupler that distributes the downward optical signal from the laser diode 41 to a number of pieces of customer premises equipment. A first transmission means consists of the optical fiber 42 and the star coupler 43. Reference numeral 44 denotes a photo diode (downward signal receiving means) that receives a downward optical signal from the star coupler 43.

Reference numeral 45 denotes a photo diode (upward signal receiving means) that receives an upward optical signal having a wavelength of 1260 nm to 1360 nm and converts the received upward optical signal into an electrical signal, reference numeral 46 denotes a video signal transmitter that generates and transmits a video signal, reference numeral 47 denotes a laser diode (video signal transmitting means) that converts the video signal (electrical signal) sent from the video signal transmitter 46 into an optical signal (referred to as video optical signal from here on) having a wavelength of 1550 nm to 1560 nm and transmits the video optical signal, and reference numeral 48 denotes a WDM (first WDM means) that allows only upward optical signals to pass therethrough for a channel from a port thereof on the side of a star coupler 50 to a port thereof on the side of the photo diode 45, and that allows only video optical signals to pass therethrough for a channel from a port thereof on the side of the laser diode 47 to the port thereof on the side of the star coupler 50.

Reference numeral 49 denotes an optical fiber. The star coupler 50 distributes the video optical signal from the WDM 48 to a number of pieces of customer premises equipment 32. The star coupler 50 also multiplexes a plurality of upward optical signals. A second transmission means consists of the optical fiber 49 and the star coupler 50. Reference numeral 51 denotes another WDM (second WDM means) that allows only upward optical signals to pass therethrough for a channel from a port thereof on the side of a laser diode 52 to a port thereof on the side of the star coupler 50, and that allows only video optical signals to pass therethrough for a channel from the port thereof on the side of the start coupler 50 to a port thereof on the side of a photo diode 53. The laser diode (upward signal transmitting means) 52 converts an upward electrical signal into an upward optical signal having a wavelength of 1260 nm to 1360 nm and transmits the optical signal, and the photo diode (information receiving means) 53 receives a video optical signal and then converts the received video optical signal into an electrical signal. Reference numeral 54 denotes a video signal receiver that receives a video signal which is the electrical signal from the photo diode 53. One WDM 51 is provided for every customer who has a video signal receiver, as shown in FIG. 1.

In operation, when the laser diode 41 of the station apparatus 31 emits a downward optical signal, the downward optical signal travels through the optical fiber 42 and then reaches the star coupler 43. The star coupler 43 distributes the downward optical signal to only a number of pieces of customer premises equipment 32. As a result, the downward optical signal is received and is converted into an electrical signal by the photo diode 44 of each customer premises equipment 32.

When the laser diode 52 of each customer premises equipment 32 emits an upward optical signal, the upward optical signal travels through the optical fiber 49 and then reaches the star coupler 50 after it passes through the WDM 51 if the WDM 51 is provided for each customer premises equipment 32. The star coupler 50 then multiplexes a plurality of upward optical signals, the number of which corresponds to the number of pieces of customer premises equipment 32. As a result, the plurality of upward optical signals multiplexed are received and are converted into an electrical signal by the photo diode 45 of the station apparatus 31 after it passes through the WDM 48 included in the station apparatus 31.

When the laser diode 47 of the station apparatus 31 emits a video optical signal, the video optical signal travels through the optical fiber 49 and then reaches the star coupler 50 after it passes through the WDM 48 included in the station apparatus. The star coupler 50 distributes the video optical signal to only the number of pieces of customer premises equipment 32. As a result, the video optical signal is received and is converted into an electrical signal by the photo diode 53 provided for every customer who has a video signal receiver after it passes through the WDM 51.

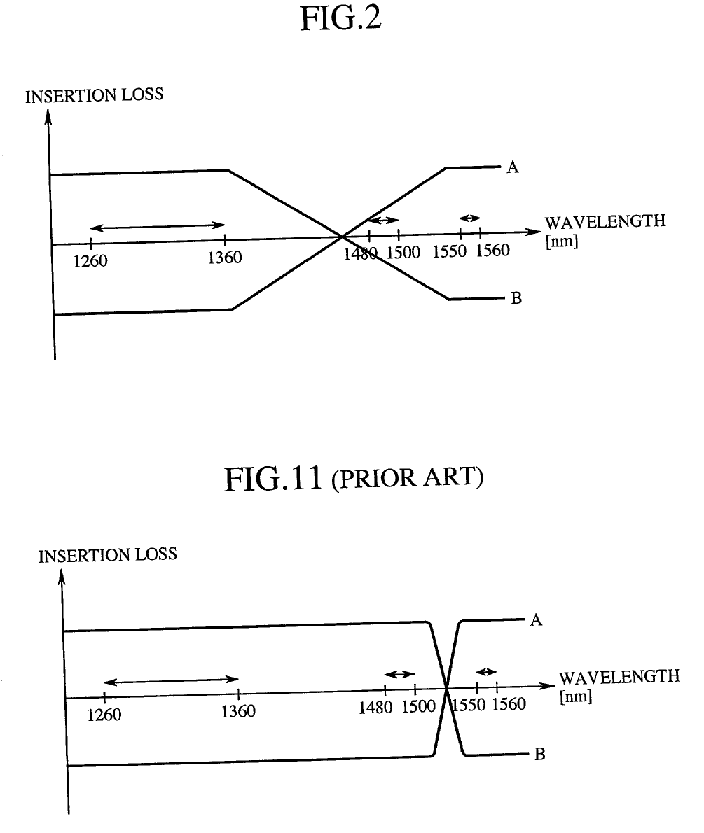

FIG. 2 is a graph showing insertion loss characteristics of the WDM 51. In the figure, A shows the insertion loss characteristics for a channel from a port on the side of corresponding customer premises equipment 32 to a port on the side of the star coupler 50, and B shows the insertion loss characteristics for a channel from the port on the side of the star coupler 50 to a port on the side of the corresponding video signal receiver 54. It is apparent from FIG. 2 that those insertion loss characteristics change gently over a wide range of wavelengths from 1360 nm and 1550 nm (the width of the wavelength range=190 nm). Therefore, it is easy to design the WDM 51, and hence the cost of the WDM 51 can be reduced.

As can be seen from the above description, in accordance with the first embodiment of the present invention, since the transmission path for downward signals and the transmission path for upward signals are so arranged that they are independent of each other, only the provision of the WDMs 48 and 51 as wavelength division multiplexer means makes it possible to transmit both upward and downward optical signals and a video optical signal. Accordingly, the present embodiment provides advantages of being able to reduce the cost of building the system, and to lengthen the transmission range of optical signals.

Furthermore, in accordance with the first embodiment of the present invention, since the laser diode 47 is so constructed as to emit a video optical signal having a wavelength longer than that of an upward optical signal emitted out of the laser diode 52 of each customer premises equipment 32, the laser diode 52 does not malfunction because of the video optical signal sent from the laser diode 47 even if no WDM is placed between the star coupler 50 and the laser diode 52 of each customer premises equipment 32.

Embodiment 2.

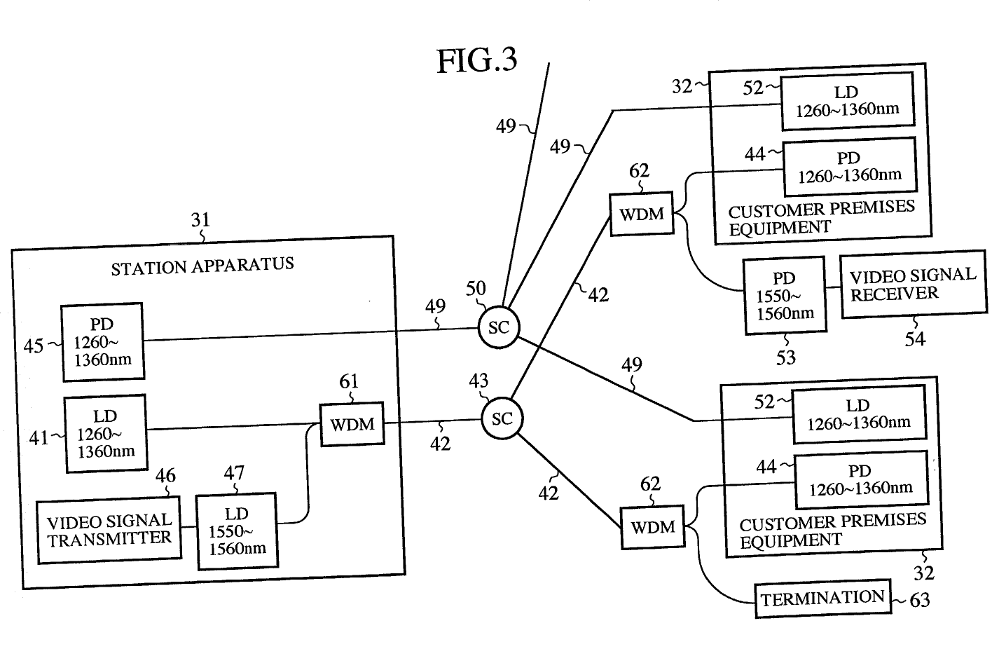

FIG. 3 is a block diagram showing the structure of a signal transmission system according to a second embodiment of the present invention. In the figure, the same reference numerals as shown in FIG. 1 denote the same components as those of the first embodiment or like components, and therefore the explanation of those components will be omitted hereafter. Reference numeral 61 denotes a WDM (first WDM means) that allows only downward optical signals to pass therethrough for a channel from a port thereof on the side of a laser diode 41 to a port thereof on the side of a star coupler 43, and that allows only video optical signals to pass therethrough for a channel from a port thereof on the side of a laser diode 47 to the port thereof on the side of the star coupler 43, reference numeral 62 another WDM (second WDM means) that allows only downward optical signals to pass therethrough for a channel from a port thereof on the side of the star coupler 43 to a port thereof on the side of a photo diode 44, and that allows only video optical signals to pass therethrough for a channel from the port thereof on the side of the start coupler 43 to a port thereof on the side of a photo diode 53, and reference numeral 63 denotes a termination. One WDM 62 is provided for each customer premises equipment 32.

In the first embodiment, an upward optical signal and a video optical signal having different wavelengths are multiplexed and transmitted, as mentioned above. In contrast, in accordance with the second embodiment of the present invention, a downward optical signal and a video optical signal having different wavelengths are multiplexed and transmitted by using the WDMs 61 and 62, as shown in FIG. 3. The second embodiment provides the same advantages as offered by the above-mentioned first embodiment.

Embodiment 3.

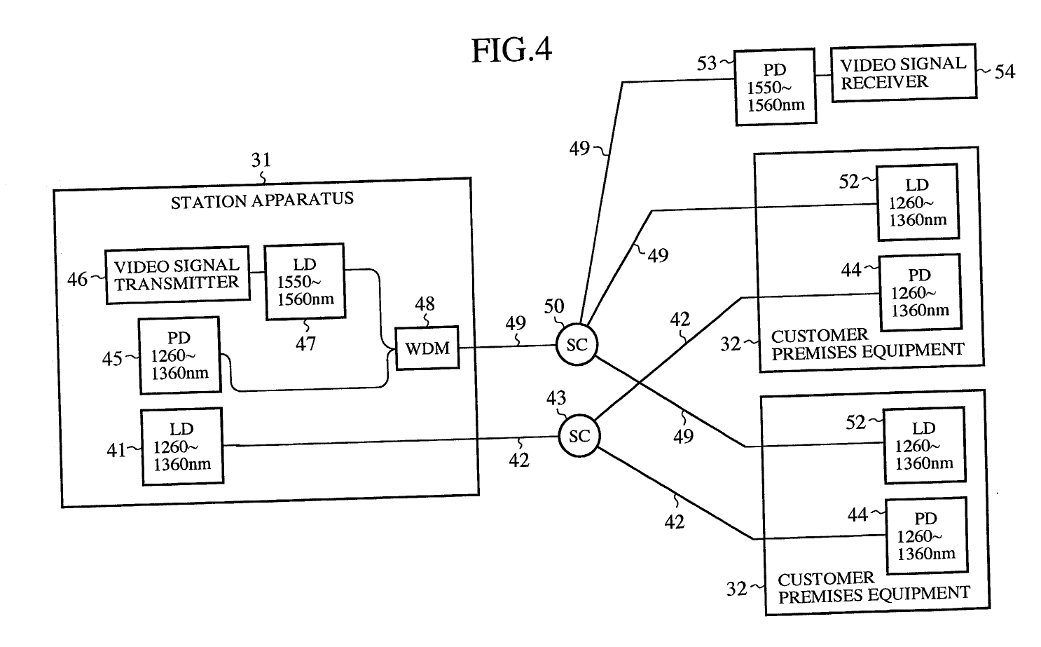

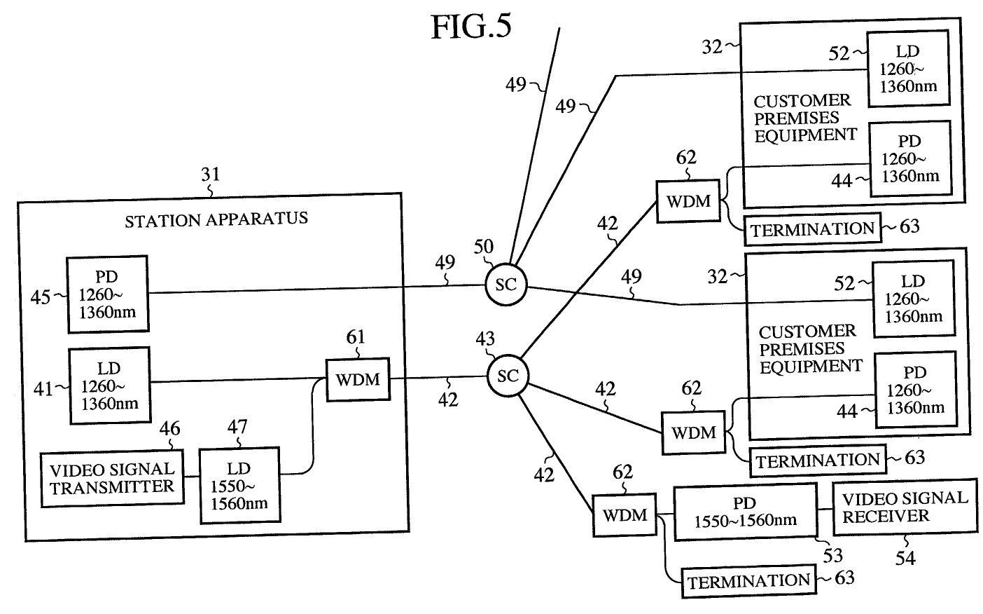

In the first and second embodiments, a video optical signal is applied to the photo diode 53 by using the WDM 51 of FIG. 1 or the WDM 62 of FIG. 3, as mentioned-above. In contrast, in accordance with a third embodiment of the present invention, a video optical signal is applied to a photo diode 53 by using a star coupler 50, as shown in FIG. 4. As an alternative, a video optical signal is applied to the photo diode 53 by using a star coupler 43, as shown in FIG. 5. Particularly, the structure of FIG. 4 makes it possible to eliminate the need for the WDM 51 of FIG. 1, and to simplify the system configuration. In FIGS. 4 and 5, the same reference numerals as shown in FIGS. 1 and 3 denote the same components as those of the first or second embodiment or like components, and therefore the explanation of those components will be omitted.

Embodiment 4.

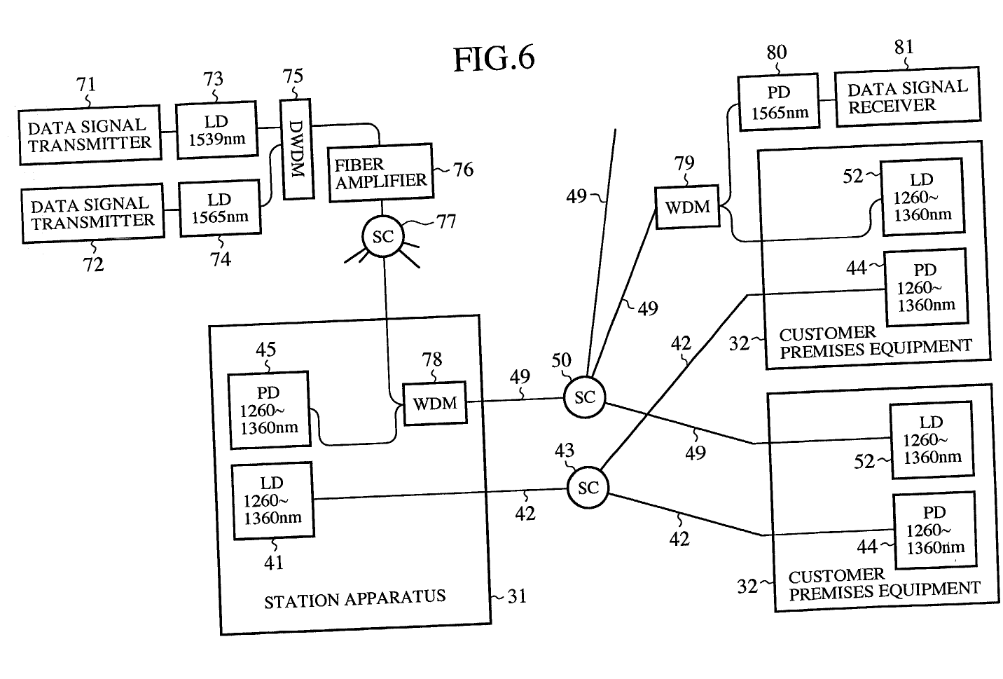

FIG. 6 is a block diagram showing the structure of a signal transmission system according to a fourth embodiment of the present invention. In the figure, the same reference numerals as shown in FIG. 1 denote the same components as those of the first embodiment or like components, and therefore the explanation of those components will be omitted hereafter. Reference numerals 71 and 72 denote data signal transmitters that generate and transmit data signals, respectively, reference numeral 73 denotes a laser diode that converts the data signal, which is an electrical signal, sent from the data signal transmitter 71 into an optical signal (referred to as data optical signal from here on) having a wavelength of 1539 nm, the optical signal carrying data, and transmits the data optical signal, reference numeral 74 denotes a laser diode that converts the data signal, which is an electrical signal, sent from the data signal transmitter 72 into an optical signal (i.e., data optical signal) having a wavelength of 1565 nm, the optical signal carrying data, and transmits the data optical signal, reference numeral 75 denotes a dense wavelength division multiplexer or DWDM, reference numeral 76 denotes a fiber amplifier, and reference numeral 77 denotes a star coupler. A data signal transmitting means consists of the data signal transmitters 71 and 72, the laser diodes 73 and 74, the DWDM 75, the fiber amplifier 76, and the star coupler 77.

Reference numeral 78 denotes a WDM (first WDM means) that allows only upward optical signals to pass therethrough for a channel from a port thereof on the side of a star coupler 50 to a port thereof on the side of a photo diode 45, and that allows only data optical signals to pass therethrough for a channel from a port thereof on the side of the start coupler 77 to the port thereof on the side of the star coupler 50, and reference numeral 79 denotes a WDM (second WDM means) that allows only upward optical signals to pass therethrough for a channel from a port thereof on the side of a laser diode 52 to a port thereof on the side of the start coupler 50, and that allows only data optical signals to pass therethrough for a channel from the port thereof on the side of the start coupler 50 to a port thereof on the side of a photo diode 80. The photo diode (information receiving means) 80 receives a data optical signal having a wavelength of 1565 nm and then converts the received data optical signal into an electrical signal. Reference numeral 81 denotes a data signal receiver that receives a data signal which is the electrical signal from the photo diode 80. One WDM 79 is provided for every customer who has a data signal receiver, as shown in FIG. 6.

In the first embodiment, a video optical signal and an upward optical signal having different wavelengths are multiplexed and transmitted, as mentioned above. In contrast, in accordance with the fourth embodiment of the present invention, a data optical signal and an upward optical signal different wavelengths are multiplexed and transmitted by using the WDMs 78 and 79, as shown in FIG. 6. The fourth embodiment provides the same advantages as offered by the above-mentioned first embodiment.

Embodiment 5.

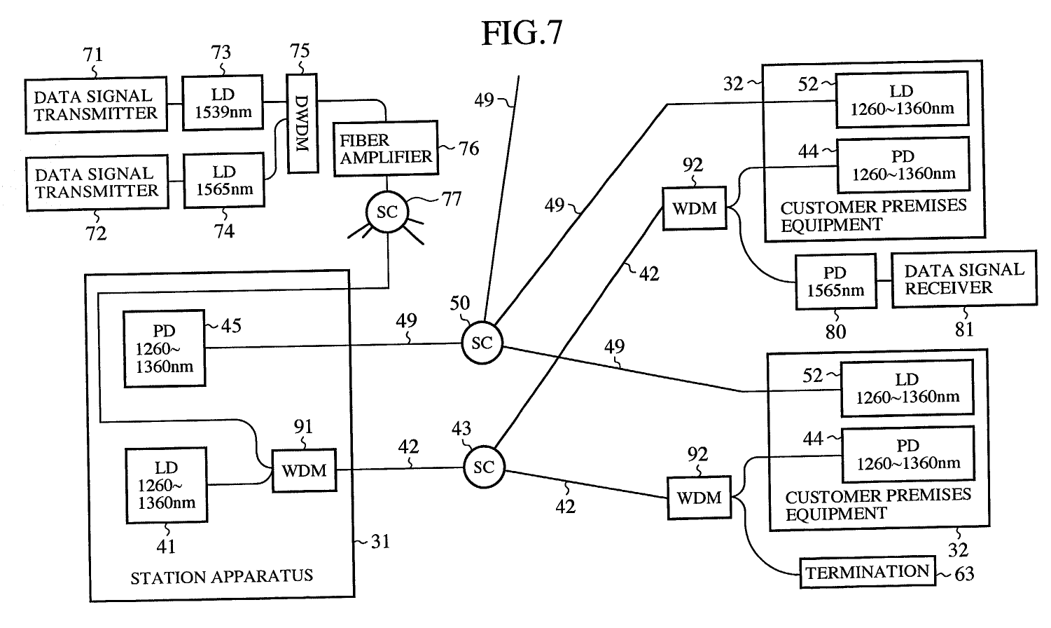

FIG. 7 is a block diagram showing the structure of a signal transmission system according to a fifth embodiment of the present invention. In the figure, the same reference numerals as shown in FIG. 6 denote the same components as those of the fourth embodiment or like components, and therefore the explanation of those components will be omitted hereafter. Reference numeral 91 a WDM (first WDM means) that allows only downward optical signals to pass therethrough for a channel from a port thereof on the side of a laser diode 41 to a port thereof on the side of a star coupler 43, and that allows only data optical signals that carry data to pass therethrough for a channel from a port thereof on the side of a star coupler 77 to the port thereof on the side of the star coupler 43, and reference numeral 92 another WDM (second WDM means) that allows only downward optical signals to pass therethrough for a channel from a port thereof on the side of the star coupler 43 to a port thereof on the side of a photo diode 44, and that allows only data optical signals to pass therethrough for a channel from the port thereof on the side of the start coupler 43 to a port thereof on the side of a photo diode 80. One WDM 92 is provided for each customer premises equipment 32.

In the fourth embodiment, an upward optical signal and a data optical signal having different wavelengths are multiplexed and transmitted, as mentioned above. In contrast, in accordance with the fifth embodiment of the present invention, a downward optical signal and a data optical signal having different wavelengths are multiplexed and transmitted by using the WDMs 91 and 92, as shown in FIG. 7. The fifth embodiment provides the same advantages as offered by the above-mentioned fourth embodiment.

Embodiment 6.

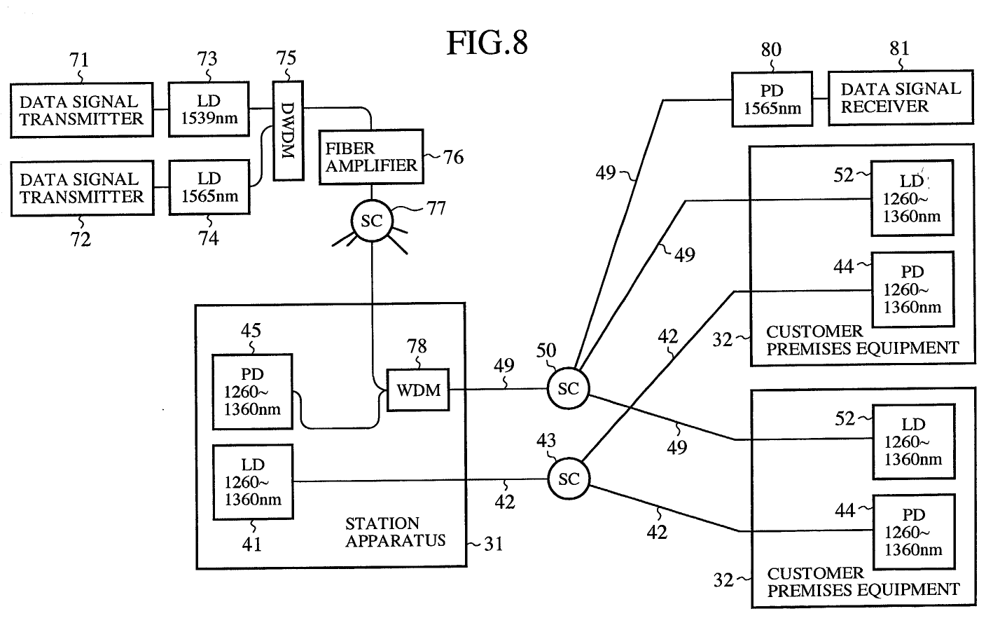

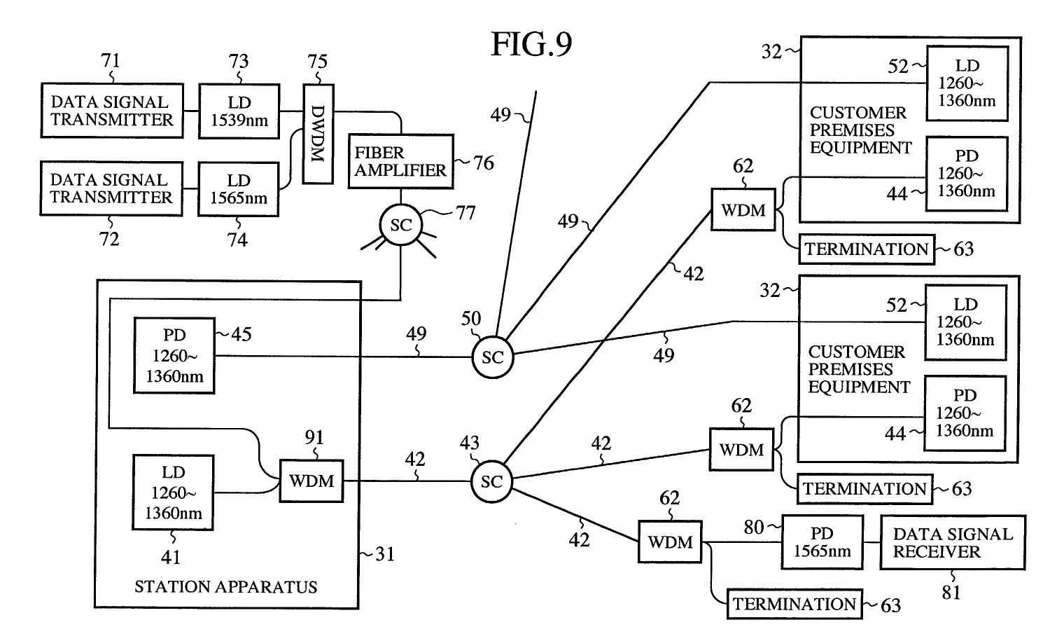

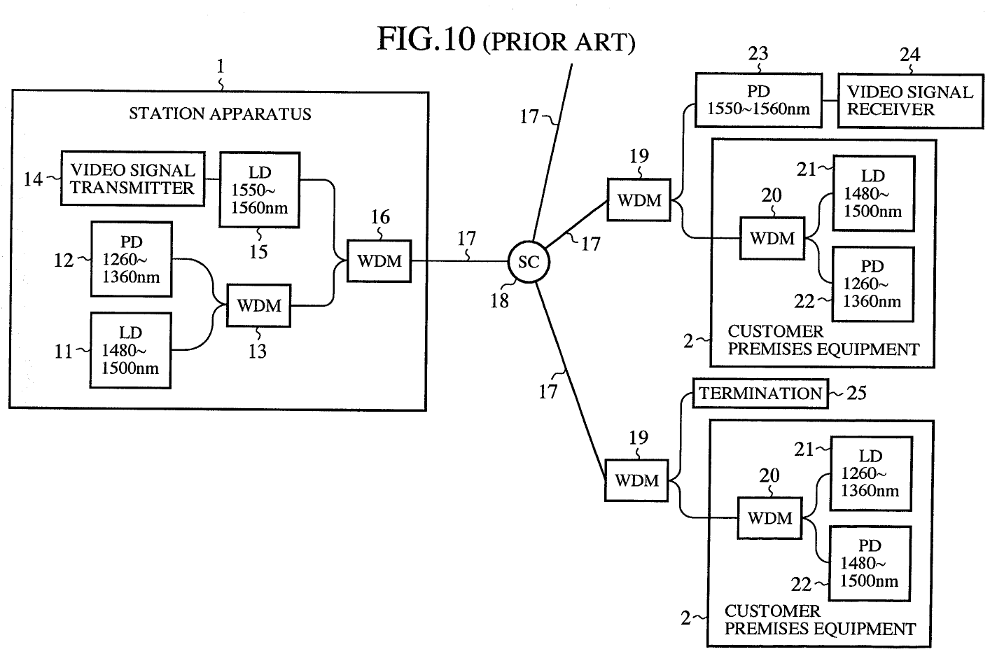

In the fourth and fifth embodiments, a data optical signal is applied to the photo diode 80 by using the WDM 79 of FIG. 6 or the WDM 92 of FIG. 7, as mentioned above. In contrast, in accordance with a sixth embodiment of the present invention, a data optical signal is applied to a photo diode 80 by using a star coupler 50, as shown in FIG. 8. As an alternative, a data optical signal is applied to the photo diode 80 by using a star coupler 43, as shown in FIG. 9. Particularly, the structure of FIG. 8 makes it possible to eliminate the need for the WDM 79 of FIG. 6, and to simplify the system configuration. In FIGS. 8 and 9, the same reference numerals as shown in FIGS. 6 and 7 denote the same components as those of the fourth or fifth embodiment or like components, and therefore the explanation of those components will be omitted.

Many widely different embodiments of the present invention may be constructed without departing from the spirit and scope of the present invention. It should be understood that the present invention is not limited to the specific embodiments described in the specification, except as defined in the appended claims.

What is claimed is:

1. A signal transmission system comprising:
a first transmission means for distributing and transmitting a downward optical signal transmitted by a downward signal transmitting means to a plurality of downward signal receiving means;
a second transmission means for multiplexing a plurality of upward optical signals applied thereto and transmitting the plurality of upward optical signals multiplexed, and for distributing and transmitting a downward signal applied thereto;
an information transmitting means for transmitting an optical signal that carries specific information;
a first WDM means for applying the plurality of upward optical signals multiplexed and transmitted thereto by said second transmission means to an upward signal receiving means, and for applying the optical signal transmitted by said information transmitting means, as a downward optical signal, to said second transmission means;
a plurality of upward signal transmitting means each for transmitting an upward signal;
an information receiving means for receiving an optical signal that carries specific information; and
a second WDM means for applying a plurality of upward optical signals transmitted by said plurality of upward signal transmitting means to said second transmission means, and for applying the optical signal from said information transmitting means transmitted thereto by said second transmission means to said information receiving means.

2. The signal transmission system according to claim 1, wherein said information transmitting means is a video signal transmitting means for transmitting the optical signal based on a video signal.

3. The signal transmission system according to claim 1, wherein said information transmitting means is a data signal transmitting means for transmitting the optical signal based on a data signal.

4. The signal transmission system according to claim 1, wherein the optical signal transmitted by said information transmitting means has a wavelength longer than those of the plurality of optical signals transmitted by said plurality of upward signal transmitting means.

5. A signal transmission system comprising:
a downward signal transmitting means for transmitting a downward optical signal;
a first transmission means for distributing and transmitting a downward optical signal applied thereto;
a second transmission means for multiplexing a plurality of upward optical signals transmitted by a plurality of upward signal transmitting means and for transmitting the plurality of upward optical signals multiplexed;
an information transmitting means for transmitting an optical signal that carries specific information;
a first WDM means for applying the downward optical signal transmitted by said downward signal transmitting means and the optical signal transmitted by said information transmitting means to said first transmission means;
an information receiving means for receiving an optical signal that carries specific information; and
a second WDM means for applying the downward optical signal distributed and transmitted thereto by said first transmission means to a plurality of downward signal receiving means, and for applying the optical signal from said information transmitting means transmitted thereto by said first transmission means to said information receiving means.

6. The signal transmission system according to claim 5, wherein said information transmitting means is a video signal transmitting means for transmitting the optical signal based on a video signal.

7. The signal transmission system according to claim 5, wherein said information transmitting means is a data signal transmitting means for transmitting the optical signal based on a data signal.

8. The signal transmission system according to claim 5, wherein the optical signal transmitted by said information transmitting means has a wavelength longer than those of the plurality of optical signals transmitted by said plurality of upward signal transmitting means.

9. A signal transmission system comprising:
a first transmission means for distributing and transmitting a downward optical signal transmitted by a downward signal transmitting means to a plurality of downward signal receiving means;
a second transmission means for multiplexing a plurality of upward optical signals transmitted by a plurality of upward signal transmitting means and transmitting the plurality of upward optical signals multiplexed, and for distributing and transmitting a downward optical signal applied thereto;
an information transmitting means for transmitting an optical signal that carries specific information;
a WDM means for applying the plurality of multiplexed upward optical signals transmitted by said second transmission means to an upward signal receiving means, and for applying the optical signal transmitted by said information transmitting means, as a downward optical signal, to said second transmission means; and
an information receiving means for receiving an optical signal that carries specific information, said second transmission means transmitting the optical signal from said WDM means to said information receiving means.

10. The signal transmission system according to claim 9, wherein said information transmitting means is a video signal transmitting means for transmitting the optical signal based on a video signal.

11. The signal transmission system according to claim 9, wherein said information transmitting means is a data signal transmitting means for transmitting the optical signal based on a data signal.

12. The signal transmission system according to claim 9, wherein the optical signal transmitted by said information transmitting means has a wavelength longer than those of the plurality of optical signals transmitted by said plurality of upward signal transmitting means.

13. A signal transmission system comprising:
a downward signal transmitting means for transmitting a downward optical signal;
a first transmission means for distributing and transmitting a downward optical signal applied thereto;
a second transmission means for multiplexing a plurality of upward optical signals transmitted by a plurality of upward signal transmitting means and for transmitting the plurality of upward optical signals multiplexed;
an information transmitting means for transmitting an optical signal that carries specific information;
a WDM means for applying the downward optical signal transmitted by said downward signal transmitting means and the optical signal transmitted by said information transmitting means to said first transmission means; and applied thereto from said WDM means to said information receiving means.

14. The signal transmission system according to claim 13, wherein said information transmitting means is a video signal transmitting means for transmitting the optical signal based on a video signal.

15. The signal transmission system according to claim 13, wherein said information transmitting means is a data signal transmitting means for transmitting the optical signal based on a data signal.

16. The signal transmission system according to claim 13, wherein the optical signal transmitted by said information transmitting means has a wavelength longer than those of the plurality of optical signals transmitted by said plurality of upward signal transmitting means.
